(19) United States
(12) Patent Application Publication
(10) Pub. No.: US 2012/0278514 A1
(43) Pub. Date: Nov. 1, 2012

(54) Systems and Methods for Notification of Quality of Service Violation

(75) Inventor: Somesh Gupta, San Jose, CA (US)

(73) Assignee: BROCADE COMMUNICATIONS SYSTEMS, INC., San Jose, CA (US)

(21) Appl. No.: 13/094,401

(22) Filed: Apr. 26, 2011

(51) Int. Cl. G06F 13/24; G06F 9/44; G06F 15/173; G06F 13/28; G06F 3/00

(52) U.S. Cl. 710/48; 710/308; 710/51; 709/223; 719/318

(57) ABSTRACT

A quality of service (QoS) notification module can provide detection and notification of violation of allocated QoS to a transmission queue. The QoS notification module can be located on a network adapter and send notifications to a host computer coupled to the network adapter. QoS notifications can indicate that one or more host transmission queues are being underserved, i.e., the bandwidth guaranteed to the one or more host queues is not being met despite the queues not being empty. Notification module can send notification to the host by writing to a memory location or a notification register in the memory of the host. Alternatively, the notification module can send an interrupt to the host processor, the interrupt including QoS notification information. The notification module can also be located in a switch for generating notifications of QoS violations of bandwidth guarantees for transmission queues associated with transmission ports of the switch.

### BACKGROUND OF THE INVENTION

1. Field of the Invention

The present invention relates generally to storage area networks. Particularly, the present invention relates to detection and notification of violation of quality of service for transmission queues.

2. Description of the Related Art

Host computers typically use network adapters, also known as network interface cards, to communicate over a network. For example, FIG. 1 shows a host 101 that can communicate over network 103 via an adapter 102. Adapter 102 can configured to communicate over more than one type of network, such as Fibre Channel, Ethernet, Fibre Channel over Ethernet (FCoE), converged enhanced Ethernet (CEE), etc. As such, the adapter 102 can include both a host bus adapter (HBA) for connecting to an FC fabric and a converged network adapter (CNA) for connecting to a CEE network. For simplicity, only the transmission module of the adapter 103 is shown in FIG. 1.

Host 101 can include host CPU 104 coupled to memory 105. Memory 105 can include one or more operating systems, device drivers, virtual machines, queues, etc., shown by block 106 and host queues 112. For example, the host 101 can include a single operating system and a single device driver associated with the adapter 103, and the host memory 105 can include a single queue. Alternatively, the host memory can include multiple queues 107-111 where each queue is assigned in terms of priority, CPU core, process, or any other classification mechanism. Also, if the host 101 and adapter 103 support virtualization, then the host may include multiple virtual machines (each running an operating system), and multiple device drivers. In such cases, each queue 107-111 may be associated with a virtual machine or a device driver.

Device drivers can translate input/output (I/O) requests from applications running on an OS into I/O transactions that can be understood by the adapter 102. I/O transactions can include sending and receiving packets to and from the network 103. Device drivers can store these transactions in a queue (e.g., 107-111), and inform the adapter 102 that there is a new transaction (also known as work item) available in the queue.

Adapter 102 can include one or more CPUs 120 coupled to memory 123 (volatile and/or non-volatile, e.g., RAM, ROM, Flash, etc.). Transmit module 121 is responsible for transmitting data from the host 101 to the network 103. MAC/Serdes block 124 forms a physical layer between transmit module 121 and the network 103. A DMA engine 122 allows components of the adapter 102, such as the transmit module 121 and the CPU 120 to read/write access to host memory 105 via the system bus 113 (e.g., PCI, PCI-e, etc.). The queue management module 125 stores mapping and control information (also known as queue context) of host queues 107-111. Queue context stores queue information such as page table address, page size, queue head and tail pointers, number of current work items, etc. With this information, the queue management module 125 can determine parameters such as whether a queue 107-111 is empty at any given time. For example, the queue management module 125 determines a queue being empty if the corresponding queue head and tail pointers are the same. Queue management module 125 receives messages (also known as doorbells) from the host 101 indicating that new work items (e.g., data transmission) have been added to one or more queues 107-111. Queue management module 125 then schedules work items appearing in host queues 107-111 based on preset priorities, and places work items in Tx buffers 127. The queue management module 125 or other modules in the transmit module 121 can access data from the host memory, referred to by the work items, and place them in the Tx buffers 127.

The transmit engine 126 can carry out arbitration, flow control, and bandwidth control in determining the order in which data stored in the Tx buffers 127 is to be transmitted onto the network 103. Arbitration can involve selecting data at the head of each of the Tx buffers 127 for transmission in a round robin fashion. Alternatively, arbitration can involve selecting data from one of the Tx buffers 127 for transmission based on preset priorities.

Flow control can block data from being transmitted over a port of the adapter 102 if the adapter receives Pause packets form a downstream device connected to the port. Typically, Pause packets indicate congestion somewhere downstream in the network. Pause functions are defined by Annex 31B of the IEEE 802.3 specification. Flow control can also alter the rate or transmission, instead of merely blocking, of packets based on flow control packets received from downstream devices. For example, in CEE networks, the flow control can receive quantized congestion notification (QCN) packets, which can indicate that the rate of transmission of packets needs to be slowed down. Flow control can be applied on the basis of priority, virtual LAN (VLAN), source/destination network addresses (e.g., MAC, IP, etc.), TCP/UDP port numbers, etc.

Bandwidth control can involve limiting data transmission from a port to a preset value. For example, a bandwidth limit value per host queue can specify the upper limit on the number of bytes from that host queue that can be transmitted onto the network (e.g., 1 Gbps for queue 107). Once this limit is reached for a preset period, no data associated with the queue is transmitted by the transmit engine 126. Bandwidth control can also involve providing bandwidth guarantees per host queue. For example, a bandwidth guarantee of 1 Gbps makes sure that a host queue is being provided a minimum of 1 Gbps of transmission bandwidth.

Thus, the transmit module 121 can implement quality of service (QoS) policies specified for the host queues 107-111. However, in certain scenarios the adapter may be failing to provide the specified QoS to a host queue. Such scenarios can include congestion at a network downstream from a port of the adapter 102, internal delays due to allocation of bandwidth greater that what a port can provide, etc. Current adapters do not provide the ability for the adapter to inform the host 101, or an administrator program running on the host 101, that the specified QoS policies for one or more of the host queues 107-111 are not being met.

### SUMMARY OF THE INVENTION

A network adapter having a QoS notification module can provide QoS notifications to a host computer coupled to the network adapter. QoS notifications can indicate that one or more host transmission queues are being underserved, i.e., the bandwidth guaranteed to the one or more host queues is not being met despite the queues not being empty.

In one embodiment, the notification module can include a sub-block for each host queue. Each sub-block can measure the current bandwidth for its associated queue, and compare it with the allocated bandwidth for the queue. If the measured bandwidth is less than the allocated bandwidth and the queue is not empty, the sub-block can generate an output indicating this condition.

In another embodiment, the notification module can include a single sub-block and a multiplexer and a de-multiplexer. The multiplexer can select data corresponding to one queue at a given time for the sub-block to generate a notification signal. By altering the selection input of the multiplexer, data corresponding to another queue can be selected at a different time. In this manner, one sub-block can be used to determine QoS notification signal for several host queues.

QoS notification can be sent to an administrator program running on the host computer. Notification may be sent to the administrator only when one or more host queues are being underserved. Alternatively, notifications can be sent repeatedly irrespective of the result of the determination of QoS by the notification module. Notification module can send notification to the host by writing to a memory location or a notification register in the memory of the host. Alternatively, the notification module can send an interrupt to the host processor, the interrupt including QoS notification information.

Both the notification module and the administrator on the host can send QoS notifications to a management entity located on the network. The notification can be sent in the form of one or more packets addressed to the management entity. The notification packets can be FC, FCoE, Ethernet, IP, etc. packets depending upon the underlying network layers.

In yet another embodiment, the notification module can be located in a network switch where the notification module determines if the QoS of any of the one or more transmission queues associated with one or more transmission ports is being violated.

### BRIEF DESCRIPTION OF THE DRAWINGS

The present invention has other advantages and features which will be more readily apparent from the following detailed description of the invention and the appended claims, when taken in conjunction with the accompanying drawings, in which:

FIG. 1 illustrates an exemplary block diagram of a host system connected to a network via an adapter;

FIG. 2 shows a block diagram of the adapter including a QoS notification module;

FIG. 3 illustrates an exemplary block diagram of the QoS notification module;

FIG. 4 illustrates an exemplary block diagram of a sub-block of the QoS notification module for measuring the current bandwidth of a queue;

FIG. 5 illustrates an exemplary block diagram of an alternative design of the QoS notification module;

FIG. 6 shows an exemplary flowchart of the steps performed by the QoS notification module;

FIG. 7 illustrates an exemplary block diagram of the QoS notification module used in a switch; and

FIG. 8 focuses on a transmit port of the switch of FIG. 7.

### DETAILED DESCRIPTION OF THE PREFERRED EMBODIMENTS

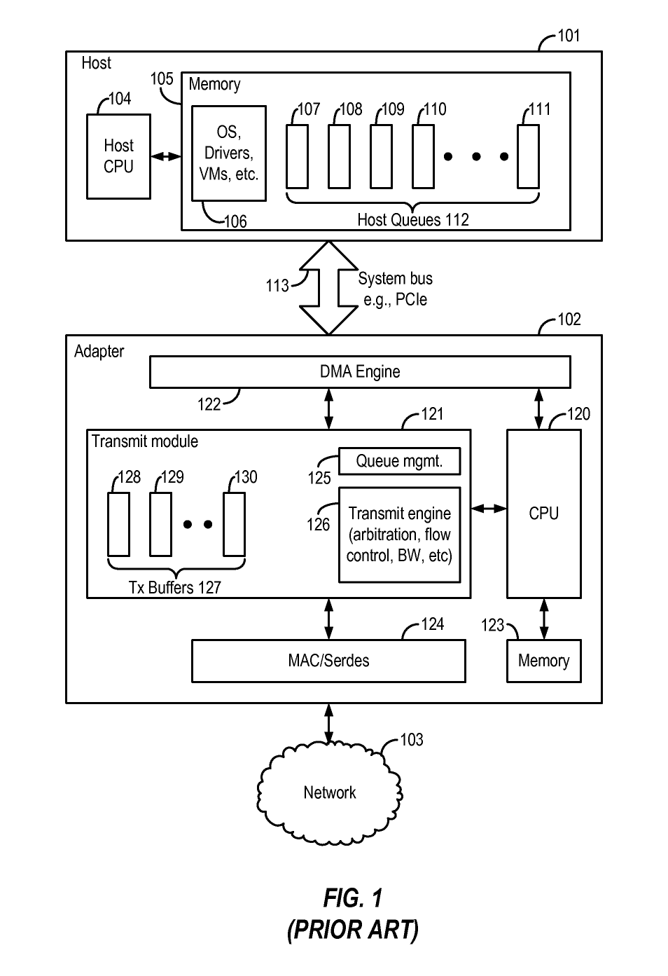

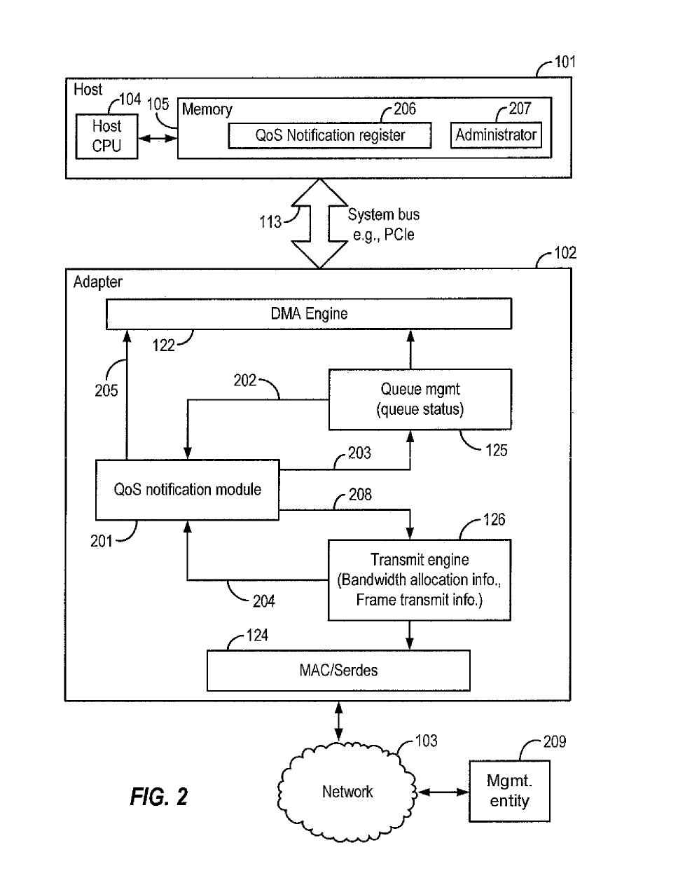

FIG. 2 shows an exemplary system for QoS notification. Adapter 102 includes a QoS notification module 201 that is responsible for generating an indication if any of the host queues 107-111 (FIG. 1) are being underserved, i.e., the specified QoS policies are not being met. Notification module 201 can receive queue status 202 from queue management module 125. Queue status 202 can include information such as whether a queue is empty or not. Transmit engine 126 can provide bandwidth allocation/guarantee and transmission information 204 for each queue. For example, transmit engine 126 can provide the allocated bandwidth for each of the queues 107-111 (FIG. 1) to the notification module 201. Additionally, the transmit engine 126 can provide the amount of data transmitted for each queue. For example, the transmit engine 126 can provide the length of frame transmitted for a particular queue. Transmit engine 126 can also provide a frame length available (FLA) signal that indicates that a frame has been transmitted for the queue, and that the frame length is available.

Notification module 201 can receive information from both the queue management module 125 and the transmit engine 126 and determine whether a queue is being underserved. Notification module 201 can transmit its results 205 to the host 101 directly via the DMA engine 122. Alternatively, the notification module 201 can send the results 203 to the queue management module 125, which in turn can transmit the results to the host 101. QoS notification results received from the adapter 102 can be stored in memory 105 of the host 101. For example, a register or memory location 206 can be reserved to store QoS notification results. An Administrator program 207 running on the host 101 can periodically examine the QoS notification register or memory location 206 to determine which of the queues 107-111 (FIG. 1) are being underserved. The Administrator program 207 can be part of a system-wide management entity, for example, the Brocade Network Advisor® sold by BROCADE®. In addition to writing to the notification register or memory location 206 the notification module 201 can also alert administrator 207 by way of interrupts. The interrupts can be sent using a bus specific mechanism (such as sending a special message in PCI-e). Upon receiving the interrupt, the host CPU 104 can invoke a device specific interrupt service routine (ISR), which in turn can alert the administrator program 207 by a wakeup thread mechanism. The ISR could also read registers in the adapter 102 to obtain additional information about the notification sent by the adapter 102.

In some instances, an administrator program or a management entity may be located on the network 103. FIG. 2 shows such a management entity 209 connected to network 103. Management entity 209 can be another host or network switch running a network management or administrator program. The notification module 201 can send notifications to management entity 209 by way of packets or messages. The notification module can send notification results 208 to transmit engine 126, which in turn can encapsulate the result in packets addressed to the management entity 209. The types of packets used can depend upon the type of the network 103. For example, if the network 103 is a FC fabric, then the notification can be sent out in the form of one or more FC frames. If the network 103 is a FCoE network, then the notification FC frames can be encapsulated in Ethernet frames. Similarly, if the network is an Ethernet network, then the notification can be sent out in the form of one or more Ethernet packets. In addition, notifications can also be sent from the administrator program 207 running on the host to the management entity 209 connected to the network 103. The notifications can be packetized and addressed to the management entity 209 by the network adapter 102.

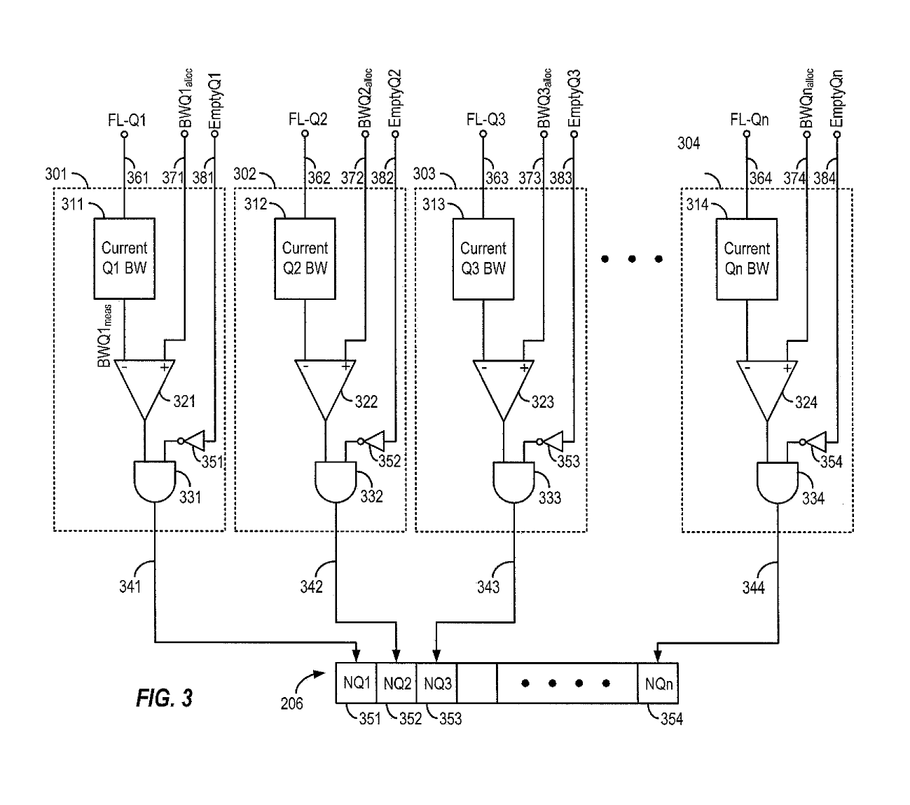

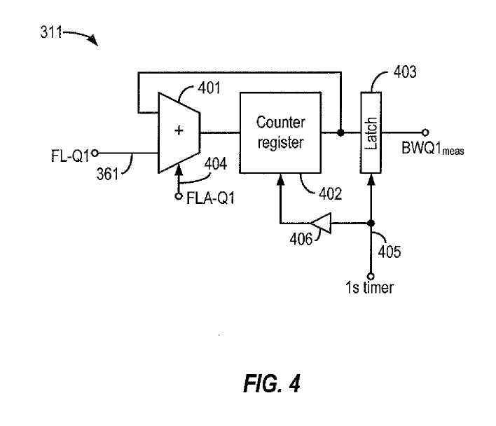

FIG. 3 shows an exemplary block diagram of the notification module 201. The notification module 201 includes notification sub-blocks for each of the host queues. For example, sub-blocks 301, 302, 303, and 304 can correspond to queues Q1, Q2, Q3, and Qn, respectively. Queues Q1, Q2, Q3, and Qn can correspond to the host queues 107-111 (FIG. 1). Each notification block 310-304 can determine whether the associated queue is being underserved despite having data to be transmitted. Referring to sub-block 301, block 311 measures the current bandwidth for queue Q1. Typically, the current bandwidth for a queue can be measured by determining the number of bytes from the queue being transmitted per second. FIG. 4 shows an exemplary circuit for measuring the current bandwidth for a queue. Signal FL-Q1 361 provides the frame length of data that has last been transmitted from queue Q1. Signal FLA-Q1 notifies that a new frame length is available. Counter register 402 stores a current value of an aggregate of frame lengths. Output of the counter register 402 is fed to a latch 403. Both the latch 403 and the counter register 402 receive a timer signal 405; however, the timer signal 405 is delayed by delay element 406 before being fed to the counter register 402. In the example shown in FIG. 4, the timer signals can be a pulse signal with a period of 1 s. However, it is understood that other periods can also be used.

The counter register 402 can be used to keep count of the number of bytes of data being transmitted, which data corresponds to queue Q1. Signal FL-Q1 361 provides the number of bytes transmitted each time a frame is transmitted. Signal FLA-Q1 404 can be activated whenever a new frame associated with queue Q1 has been transmitted. The new frame length is provided at signals FL-Q1 361. FLA-Q1 404 enables adder 401 only when a new frame length is available, so that the new frame length can be added to a value stored in counter register 402. Each time a new frame length is transmitted, the FLA-Q1 404 signal can be activated to enable the adder 401 to add a new value of frame length available at signal FL-Q1 361 to the previous value stored in the counter register 402. In this manner, the counter register 402 accumulates the number of bytes being transmitted for queue Q1 for a duration specified by the timer signal 405.

Timer signal 405 can be used to read out the current value of counter register 402 and store it in the latch 403, and also to reset the value of counter register to 0. Because the timer signal 405 arrives at 1 second durations, the value of the counter register 402 is read in 1 second durations. Therefore, the value of counter register 402 stored in the latch 403 is equivalent to the number of bytes transmitted for queue Q1 per second, i.e., the measured bandwidth BWQ1ₘₑₐₛ for queue Q1. As mentioned previously, the value of timer signal 405 can have values different than 1 second. For example, the timer may have a value anywhere from a few microseconds to multiple seconds. The actual value used can be based on the granularity of the timeframe over which the QoS guarantees are to be measured. In some cases, the measured bandwidth for a particular queue can be directly obtained from the transmit engine 126. In such cases, the bandwidth measurement blocks 311, 312, 313, and 314 can be eliminated.

Returning to FIG. 3, the measured bandwidth BWQ1ₘₑₐₛ for queue Q1 is fed to one of the inputs of a comparator 321. BWQ1ₘₑₐₛ is compared with a value BWQ1_{alloc} equal to the bandwidth allocated or guaranteed to queue Q1. If the measured bandwidth value is smaller than the allocated bandwidth for queue Q1, then the output of the comparator 321 will be F. In other words, if BWQ1ₘₑₐₛ<BWQ1_{alloc}, then output of comparator is ‘1’ and ‘0’ otherwise. In one embodiment, the comparator can be implemented using a 2's complement subtractor, in which the most significant bit (MSB), representing the sign bit, is used as an output of the comparator.

Output of the comparator 321 is fed to an AND gate 331, the other input of which receives signal EmptyQ1 381 via inverter 351. Signal EmptyQ1 381 indicates whether queue Q1 is empty. If queue Q1 is empty, then signal EmptyQ1 381 can have a value ‘1’, while if queue Q1 is not empty then the signals EmptyQ1 can have a value ‘0’. If both inputs of the AND gate 331 are ‘1’, then it means that the measured bandwidth for queue Q1 is less than the allocated bandwidth, and that queue Q1 is not empty. Under this condition, the output of the AND gate 331 will be ‘1’.

Similar to AND gate 331, outputs of AND gates 332, 333, and 334 will also be ‘1’ if the measured bandwidth for the associated queue is less than the allocated bandwidth and the associated queue is not empty. Outputs of AND gates 331-334 can be fed to one bit each of the notification register 206. As described previously with respect to FIG. 2, the notification module 201 can directly update the notification register 206 via the DMA engine 122 or can provide the results to the queue management module 125, which in turn, can update the notification register 206. In one embodiment, the notification register 206 is updated only when a queue is being underserved. In other words, notification register 206 is updated with the output of the notification module 201 only when any one of the outputs of the AND gates 331-334 is ‘1’.

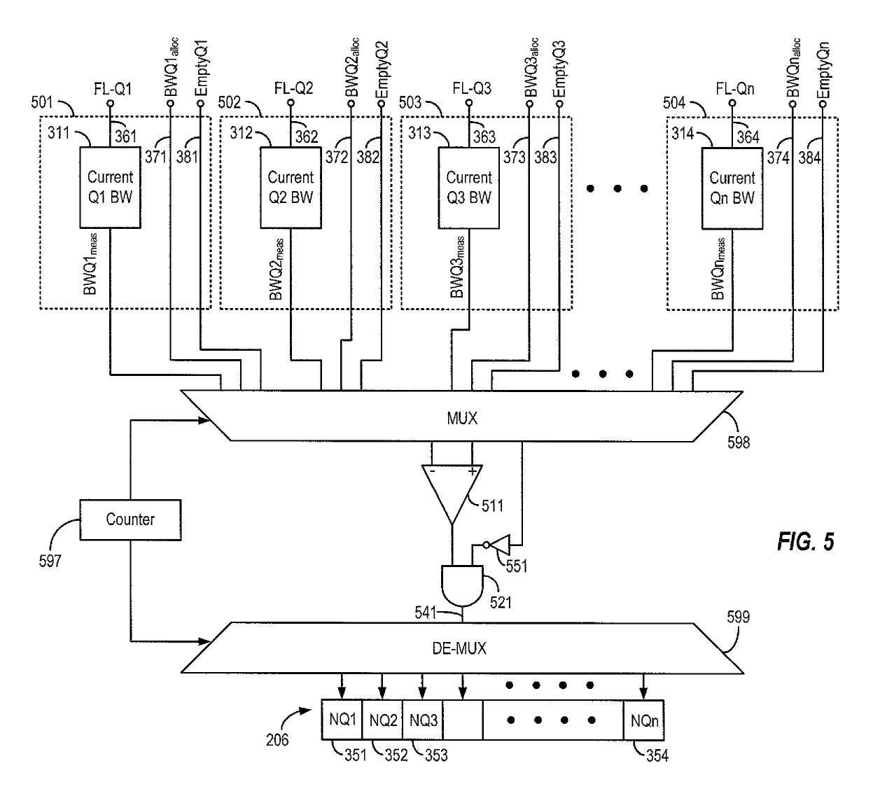

While FIG. 4 shows a comparator and an AND gate being used for each sub-block 301-304, FIG. 5 shows an alternative architecture, in which only one comparator 511 and AND gate 521 is used. As shown, sub-blocks 501-504 include bandwidth measurement blocks 311-314. Output of blocks 501-504 can be coupled with the comparator 511, inverter 551, and AND gate 521 via a multiplexer (MUX) 598. MUX 598 can select outputs of any one of the blocks 501-504 at any given time and generate an output signal 541, which is connected to an input of a de-multiplexer (DE-MUX) 599. DE-MUX 599 can select any of its outputs to be connected to the input signal 541. Counter 597 can operate as a selection input for both the MUX 598 and the DE-MUX 599. For example, if the counter value is 1, then MLA 598 can couple signals from sub-block 501 with the comparator 511, inverter 551, and AND gate 521; and DE-MUX 599 can associate the output signal 541 to bit NQ1 351 of the notification register 206. The counter can then increment to 2, 3, and so on up to n, with each increment updating a bit value in the notification register 206. After the counter reaches n, it can be configured to restart its count from 1. The time duration between each increment of counter 597 can depend upon the amount of time it takes for the result to appear at the output of the DE-MUX 599 after the signals at an input of the MUX 598 become available.

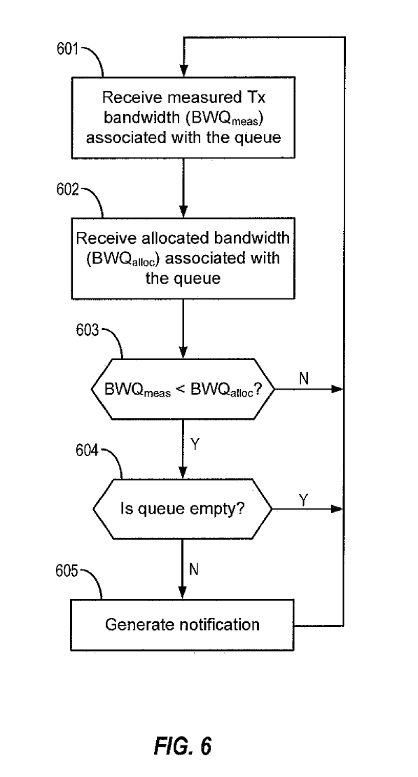

While FIGS. 3-5 showed exemplary logic circuit implantations of the notification module 201, the notification module 201 can alternatively be implemented using a microcontroller, a state machine, etc. As an example, the notification module can also be implemented on the CPU 120 of the adapter 102. FIG. 6 shows an exemplary flowchart of the steps performed by the notification block to generate QoS notification. In steps 601 and 602, the notification block can receive the measured bandwidth BWQₘₑₐₛ and the allocated bandwidth BWQ_{alloc} for a particular queue. In step 603, the notification block can compare the measured bandwidth BWQₘₑₐₛ to the allocated bandwidth BWQ_{alloc}. If the measured bandwidth for the queue is less than the allocated bandwidth, then the queue may be underserved. To determine whether the queue is actually been underserved, the notification module can determine whether the queue is empty in step 604. If the queue is empty, then the queue is not been underserved. The queue not being empty can, on the other hand, indicates that the despite data being scheduled for transmission, the allocated bandwidth for the queue is not being met. Therefore, the notification block can generated a notification in step 605. Steps 601-605 can be repeated for each host queue.

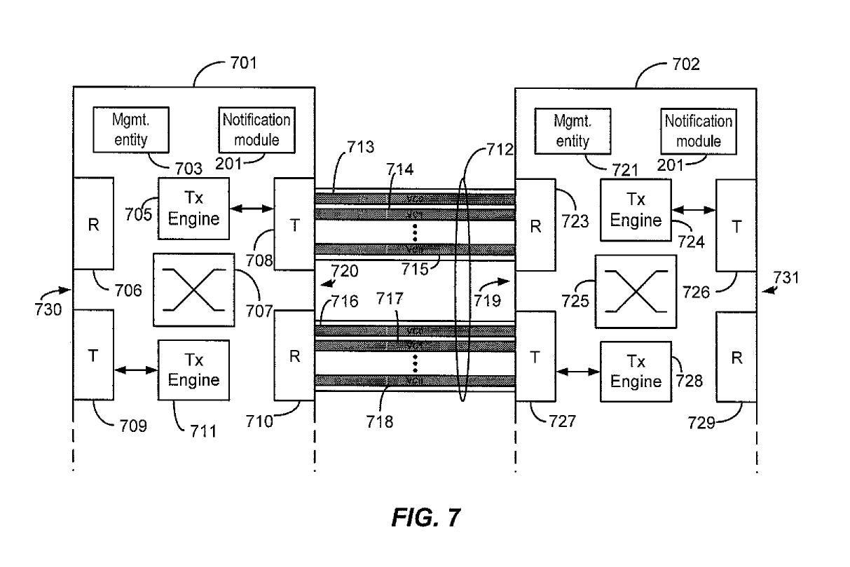

The notification module 201 can also be used in environments other than the host-adapter configuration shown in FIG. 2. For example, the notification module 201 can be used to notify QoS violations in a switch as well. FIG. 7 illustrates two switches 701 and 702 having ports 720 and 719 connected via an inter-switch link (ISL) 712. Each port can have a receiver and transmitter. For example, port 720 includes transmitter 708 and receiver 710. Similarly, port 719 on switch 702 includes transmitter 727 and receiver 723. Each switch can further include switch constructs 707 and 725. A switch construct can include a crossbar switch or equivalent circuit and control logic. A switch construct can direct frames received at any port in the switch to any other port on the same switch. Switches 701 and 702 can also include additional ports, such as ports 730 and 731. Each switch 701 and 702 can also include a notification module 201 and a management entity (703 and 721), such as an administrator software. The broken lines at the bottom of the switches 701 and 702 denote that the switch can include additional ports and processing modules.

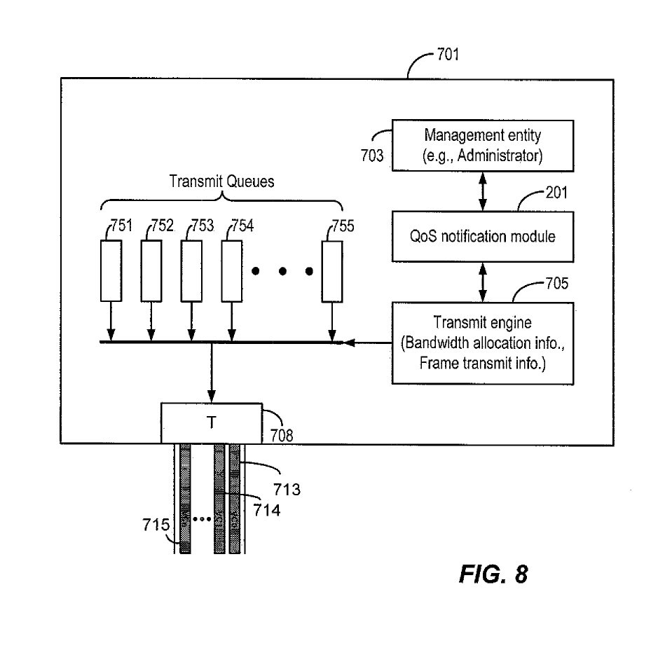

Ports 719 and 720 can include one or more logical channels VC0-VCn 713-718, also known as virtual channels in Fibre Channel networks. Each virtual channel can be allocated its own queue within the switch (as described below with reference to FIG. 8). The Tx engine 705, for example, determines the virtual channel that an outgoing frame needs to be on. The Tx engine 705 can then place the frame in the queue corresponding to that virtual channel. Typically, frames with the same source and destination (denoted by, e.g., S_ID and D_ID) pair are sent and received via the same virtual channel. However, each virtual channel can carry frames having various source destination pairs. In other words, each virtual channel VC0-VCn 713-718 can carry frames associated with different data flows.

FIG. 8 focuses on the transmit port 708 of switch 701, showing a number of transmit queues 751-755 associated with each virtual channel VC0-VCn 713-715. The transmit engine 705 can select data from any one of the queues 751-755 for transmission via the transmit port T 708. The selection can be based on specified QoS policies, for example, on the allocated bandwidth BW_{alloc} associated with each virtual channel. Transmit engine 705 may also base the selection on flow control requirements, such as whether it has enough transmit credits available to allow transmission of a packet from the transmit port 208. In any event, the virtual channels, and hence the transmit queues 751-755 may be underserved due to, for example, flow control requirements, over allocation of the transmit port 208 bandwidth, etc.

The notification module 201 can monitor and determine whether any of the transmit queues 751-755 are being underserved, i.e., whether the bandwidth guaranteed to one or more of the transmit queues is not being met despite the queues not being empty. The transmit engine can provide the notification module 201 with information such as allocated bandwidth BW_{alloc}, BWₘₑₐₛ, transmitted frame length (FL), and frame length available (FLA) associated with each of the transmit queues 751-755. The notification module 201 can generate notifications based on this information and send it to the management entity 703. Notifications can be sent in the form of writing to a memory location that can be accessed by the management entity 703, hardware/software interrupts, plaintext or encoded messages, etc. The management entity 703 can subsequently send the notification to another management entity located outside the switch and connected to the network 103 (e.g., management entity 209 of FIG. 2). The notification module 201 can in addition (or alternatively) itself send notifications to the management entity located outside the switch and connected to the network 103. It is understood that the Tx engine 705 can encapsulate the notifications in the proper packet format based on the type of network 103.

The above description is illustrative and not restrictive. Many variations of the invention will become apparent to those skilled in the art upon review of this disclosure. The scope of the invention should therefore be determined not with reference to the above description, but instead with reference to the appended claims along with their full scope of equivalents.

1. A method, comprising:
generating, by a network device, a notification if a measured bandwidth for a queue is less than an allocated bandwidth for the queue and the queue is not empty,
wherein the allocated bandwidth is a portion of a bandwidth provided by a network port from which data specified by the queue is transmitted.

2. The method of claim 1, further comprising sending the generated notification to a host computer where the queue resides.

3. The method of claim 2, further comprising sending the generated notification in the form of one or more packets from the host computer to a management entity over a communication network.

4. The method of claim 2, wherein the generated notification is sent from a network adapter coupled to the host computer.

5. The method of claim 2, wherein sending the generated notification comprises writing to a notification register in the host computer.

6. The method of claim 2, wherein sending the generated notification comprises sending an interrupt to the host computer.

7. The method of claim 4, wherein the queue includes a set of work items, each work item defining data to be transmitted from the host computer to a network via the network adapter.

8. The method of claim 1, further comprising sending the generated notification to a switch where the queue resides.

9. The method of claim 8, wherein the queue includes a set of work items, each work item defining data to be transmitted from the network port of the switch.

10. The method of claim 8, wherein sending the generated notification further comprises sending the notification to a management entity located on the switch.

11. The method of claim 1, further comprising sending the generated notification in the form of one or more packets to a management entity over a communication network.

12. The method of claim 11, wherein the management entity is located at a switch in the communication network.

13. A notification module, comprising:
a comparator for comparing a measured transmission bandwidth for a transmission queue with an allocated bandwidth for the transmission queue; and
a logic circuit for generating a notification if the transmission queue is not empty and an output of the comparator indicates that the measured transmission bandwidth is less than the allocated bandwidth,
wherein the allocated bandwidth is a portion of a transmission bandwidth provided by a network port from which data specified by the transmission queue is transmitted.

14. The notification module of claim 13, wherein the notification module is located in a network adapter, the network adapter coupled to a host computer, and wherein the transmission queue is located in the host computer.

15. The notification module of claim 14, wherein the notification is sent from the network adapter to a first management entity in the host computer.

16. The notification module of claim 14, wherein the notification is sent by the host computer via the network adapter to a second management entity located in a network.

17. The notification module of claim 13, wherein the notification module is located in a network switch, and wherein the transmission queue specifies data to be transmitted via a transmission port of the network switch.

18. The notification module of claim 17, wherein the notification is sent to a management entity located in the switch.

19. A method, comprising:
measuring a transmission bandwidth for each of a plurality of transmission queues of a host computer;
comparing, for each of the plurality of transmission queues, the measured transmission bandwidth with an allocated bandwidth;
generating, for each of the plurality of transmission queues, a QoS notification if the measured transmission bandwidth is less than the allocated bandwidth and the transmission queue is not empty; and
sending generated QoS notifications to the host computer,
wherein the allocated bandwidth is a portion of a bandwidth provided by a network port from which data specified by the plurality of transmission queues is transmitted.

20. The method of claim 19, wherein the plurality of transmission queues include data from a plurality of virtual machines running on the host computer.

21. The method of claim 19, wherein sending generated QoS notifications to the host computer comprises writing to a notification register in a memory of the host computer.

22. The method of claim 19, wherein sending generated QoS notifications to the host computer comprises sending an interrupt to the host computer.

23. The method of claim 19, wherein each of the plurality of transmission queues include a set of work items, each work item defining data to be transmitted from the host computer to a network via the network adapter.

24. A network adapter, comprising:
a host interface configured to couple to a host computer; and
a notification module assigned to a transmission queue in the host computer, the notification module configured to send a notification to the host computer via the host interface if a measured bandwidth of the transmission queue is less than an allocated bandwidth of the transmission queue and the transmission queue is not empty,
wherein the allocated bandwidth is a portion of a bandwidth provided by a network port from which data specified by the transmission queue is transmitted.

25. The network adapter of claim 24, further comprising a direct memory access (DMA) engine configured to provide access to a memory of the host computer via the host interface, wherein the notification module is configured to send the notification by requesting the DMA engine to write to a memory location on the memory of the host computer.

26. The network adapter of claim 24, wherein the notification module is configured to send the notification by sending an interrupt to the host computer via the host interface.

27. A system comprising:
a host computer having a memory, the memory having a plurality of transmission queues;
a network adapter coupled to the host computer via a system bus, the network adapter comprising a notification module configured to send a notification to the host computer if a measured bandwidth of at least one of the plurality of transmission queues is less than an allocated bandwidth of the at least one of the plurality of transmission queues and the at least one of the plurality of transmission queues is not empty,
wherein the allocated bandwidth is a portion of a bandwidth provided by a network port from which data specified by the plurality of transmission queues is transmitted.

28. The system of claim 27, wherein the notification module comprises:
a plurality of sub-modules, each of the plurality of sub-modules assigned to one of the plurality of transmission queues, at least one sub-module comprising:
a comparator for receiving the measured bandwidth and the allocated bandwidth for the at least one of the plurality of transmission queues, the comparator output configured to be logic high if the measured bandwidth is less than the allocated bandwidth;
an AND gate receiving the comparator output as one of its inputs and receiving a signal indicating that the at least one of the plurality of transmission queues is not empty at another of its inputs,
wherein combined outputs of the plurality of sub-modules form the notification.

29. The system of claim 27, wherein the notification module comprises:
a multiplexer receiving a plurality of groups of inputs, each group corresponding to one of the plurality of transmission queues, each group comprising a measured bandwidth value, an allocated bandwidth value, and a queue not empty signal for the corresponding one of the plurality of transmission queues, the multiplexer selecting one group from the plurality of groups of inputs based on a selection signal and providing the selected group of inputs as outputs of the multiplexer,
a sub-module coupled to the outputs of the multiplexer, comprising:
a comparator receiving the measured bandwidth value and the allocated bandwidth value as inputs generating a logic high signal at its output if the measured bandwidth value is less than the allocated bandwidth value; and
an AND gate receiving the comparator output as one of its input and the queue not empty signals as another of its input, and
a de-multiplexer comprising an input coupled to an output of the AND gate and a plurality of outputs, wherein a number of plurality of outputs is equal to a number of plurality of transmission queues, the de-multiplexer selecting one of the plurality of outputs based on the selection signal and providing a signal at its input at the selected one of the plurality of outputs,
wherein the plurality of outputs of the de-multiplexer form the notification.

30. The system of claim 27, the network adapter further comprising a direct memory access (DMA) engine coupled with the notification module, the DMA engine configured to provide access to a memory of the host computer, wherein the notification module is configured to send the notification by requesting the DMA engine to write to a memory location on the memory of the host computer.

31. The system of claim 27, wherein the notification module is configured to send the notification by sending an interrupt to the host computer.

32. The system of claim 27, wherein at least one of the plurality of transmission queues includes data from a virtual machine running on the host computer.

33. The system of claim 32, wherein the at least one of the plurality of transmission queues includes a set of work items, each work item defining data to be transmitted from the host computer to a network via the network adapter.
